(19) United States
(12) Patent Application Publication
(10) Pub. No.: US 2026/0298656 A1
(43) Pub. Date: Oct. 1, 2026

(54) SYSTEMS AND METHODS FOR CONSTRUCTING A ROAD NETWORK IN AN ENVIRONMENT

(71) Applicant: ROCKWELL AUTOMATION CANADA LTD., Cambridge (CA)

(72) Inventors: Robert BRADFORD, Ajax (CA); Omar Serag Mohamed Serag ELMOFTY, Cambridge (CA); Joao Ricardo MACHADO, Woodstock (CA); Jason MERCER, Kitchener (CA); Ivor WANDERS, Kitchener (CA); Ryan Christopher GARIEPY, Waterloo (CA); Matthew Allen RENDALL, Waterloo (CA)

(21) Appl. No.: 19/096,017

(22) Filed: Mar. 31, 2025

(51) Int. Cl. G01C 21/00

(52) U.S. Cl. CPC G01C 21/3815; G01C 21/3841

(57) ABSTRACT

Systems and methods for interpreting navigation features provided by a user for constructing a road network autonomously navigable for at least one self-driving vehicle are disclosed. The method includes receiving the navigation features, the navigation features comprising at least one navigable path and one or more navigation constraints for the environment; evaluating the navigable features based at least on one or more vehicle properties of a self-driving vehicle, including decomposing the at least one navigable path into one or more path segments and one or more intersections based on the one or more navigation constraints; generating one or more operational paths by adapting each path segment and each intersection to accommodate for the one or more vehicle properties; and constructing the road network with the one or more operational paths; and operating the self-driving vehicle to collect environmental data while autonomously navigating the environment for updating the road network.

### FIELD

The described embodiments relate to constructing a road network autonomously navigable for self-driving vehicles in an environment.

### BACKGROUND

Self-driving (e.g., autonomous) vehicles represent significant advantages when navigating within an environment. For example, self-driving vehicles can be used as material transport vehicles within an industrial facility. Each self-driving vehicle requires commissioning before it can autonomously navigate an environment. Commissioning involves specifying where and how the self-driving vehicle can navigate throughout the environment. For example, commissioning can involve specifying which paths the self-driving vehicle can navigate along, how the self-driving vehicle behaves at intersecting points of paths, and endpoints at which the self-driving vehicle performs certain tasks. Currently, commissioning is performed manually by an expert.

Some environments, such as industrial facilities, can involve complex layouts with numerous endpoints and several self-driving vehicles navigating the environment simultaneously. Accordingly, the commissioning process for self-driving vehicles navigating in such environments can require significant time and expertise. An improved means of commissioning self-driving vehicles is desired.

### SUMMARY

The various embodiments described herein generally relate to systems and methods for constructing a road network autonomously navigable for self-driving vehicles in an environment.

In a first aspect, there is a method for interpreting navigation features provided by a user for constructing a road network autonomously navigable for at least one self-driving vehicle, the method including: receiving the navigation features provided by the user for an environment, the navigation features including at least one navigable path and one or more navigation constraints for the environment; evaluating the navigable features based at least on one or more vehicle properties of a self-driving vehicle to construct the road network for the self-driving vehicle, including decomposing the at least one navigable path into one or more path segments and one or more intersections based on the one or more navigation constraints provided by the user; generating one or more operational paths for the self-driving vehicle by adapting each path segment and each intersection to accommodate for the one or more vehicle properties of the self-driving vehicle; and constructing the road network for the self-driving vehicle with the one or more operational paths; and operating the self-driving vehicle to collect environmental data while autonomously navigating the environment for updating the road network.

According to some embodiments, generating the one or more operational paths for the self-driving vehicle by adapting each path segment and each intersection to accommodate for the one or more vehicle properties of the self-driving vehicle includes, for each path segment: evaluating whether the one or more navigation constraints provided by the user is compatible with the one or more vehicle properties; and in response to determining that the one or more vehicle properties is incompatible with the one or more navigation constraints, adapting that path segment to accommodate the one or more vehicle properties and the one or more navigation constraints.

According to some embodiments, decomposing the at least one navigable path into one or more path segments and one or more intersections based on the one or more navigation constraints provided by the user includes identifying an end point from the navigation features; and generating the one or more operational paths for the self-driving vehicle to incorporate characteristics of the end point.

According to some embodiments, generating the one or more operational paths for the self-driving vehicle by adapting each path segment and each intersection to accommodate for the one or more vehicle properties of the self-driving vehicle includes determining an intersection type of each intersection; determining one or more available operational movements for the self-driving vehicle at the intersection type based on the one or more vehicle properties of the self-driving vehicle; and generating the one or more operational paths to account for the one or more available operational movements.

According to some embodiments, decomposing the at least one navigable path into the one or more path segments and the one or more intersections based on the one or more navigation constraints provided by the user includes determining an intersection type of each intersection; and automatically incorporating relevant navigation prompts at that intersection between the one or more path segments.

According to some embodiments, decomposing the at least one navigable path into the one or more path segments and the one or more intersections based on the one or more navigation constraints provided by the user includes determining one or more path characteristics defined by the user for each path segment; and assigning the one or more path characteristics to that path segment.

According to some embodiments, operating the self-driving vehicle to collect the environmental data while autonomously navigating the environment for updating the road network includes operating a sensor system coupled to the self-driving vehicle for collecting the environmental data; and determining from the environmental data that a variation to the road network is required based at least on one or more of an operational incompatibility with the navigation features provided by the user and an environmental change.

According to some embodiments, the at least one self-driving vehicle includes a first self-driving vehicle having a first set of vehicle properties and a second self-driving vehicle having a second set of vehicle properties, and evaluating the navigable features based at least on the one or more vehicle properties of the self-driving vehicle to construct the road network for the self-driving vehicle includes constructing a first road network for the first self-driving vehicle and a second road network for the second self-driving vehicle, the first road network being different from the second road network.

According to some embodiments, the method further includes detecting the road network is disconnected from a neighbouring road network constructed for the self-driving vehicle; and in response to detecting the neighbouring road network, operating the self-driving vehicle to autonomously navigate between the road network and the neighbouring road network.

In another aspect, there is a system for interpreting navigation features provided by a user for constructing a road network autonomously navigable for at least one self-driving vehicle, the system including: the at least one self-driving vehicle operable to autonomously navigate the road network; and a processor operable to receive the navigation features provided by the user for an environment, the navigation features including at least one navigable path and one or more navigation constraints for the environment; evaluate the navigable features based at least on one or more vehicle properties of a self-driving vehicle to construct the road network for the self-driving vehicle, including decomposing the at least one navigable path into one or more path segments and one or more intersections based on the one or more navigation constraints provided by the user; generating one or more operational paths for the self-driving vehicle by adapting each path segment and each intersection to accommodate for the one or more vehicle properties of the self-driving vehicle; and constructing the road network for the self-driving vehicle with the one or more operational paths; and operate the self-driving vehicle to collect environmental data while autonomously navigating the environment for updating the road network.

According to some embodiments, generating the one or more operational paths for the self-driving vehicle by adapting each path segment and each intersection to accommodate for the one or more vehicle properties of the self-driving vehicle includes, for each path segment: evaluating whether the one or more navigation constraints provided by the user is compatible with the one or more vehicle properties; and in response to determining that the one or more vehicle properties is incompatible with the one or more navigation constraints, adapting that path segment to accommodate the one or more vehicle properties and the one or more navigation constraints.

According to some embodiments, decomposing the at least one navigable path into one or more path segments and one or more intersections based on the one or more navigation constraints provided by the user includes identifying an end point from the navigation features; and the processor is further operable to generate the one or more operational paths for the self-driving vehicle to incorporate characteristics of the end point.

According to some embodiments, generating the one or more operational paths for the self-driving vehicle by adapting each path segment and each intersection to accommodate for the one or more vehicle properties of the self-driving vehicle includes determining an intersection type of each intersection; determining one or more available operational movements for the self-driving vehicle at the intersection type based on the one or more vehicle properties of the self-driving vehicle; and generating the one or more operational paths to account for the one or more available operational movements.

According to some embodiments, decomposing the at least one navigable path into the one or more path segments and the one or more intersections based on the one or more navigation constraints provided by the user includes determining an intersection type of each intersection; and automatically incorporating relevant navigation prompts at that intersection between the one or more path segments.

According to some embodiments, decomposing the at least one navigable path into the one or more path segments and the one or more intersections based on the one or more navigation constraints provided by the user includes determining one or more path characteristics defined by the user for each path segment; and assigning the one or more path characteristics to that path segment.

According to some embodiments, operating the self-driving vehicle to collect the environmental data while autonomously navigating the environment for updating the road network includes operating a sensor system coupled to the self-driving vehicle for collecting the environmental data; and determining from the environmental data that a variation to the road network is required based at least on one or more of an operational incompatibility with the navigation features provided by the user and an environmental change.

According to some embodiments, the at least one self-driving vehicle includes a first self-driving vehicle having a first set of vehicle properties and a second self-driving vehicle having a second set of vehicle properties, and evaluating the navigable features based at least on the one or more vehicle properties of the self-driving vehicle to construct the road network for the self-driving vehicle includes constructing a first road network for the first self-driving vehicle and a second road network for the second self-driving vehicle, the first road network being different from the second road network.

According to some embodiments, the processor is further operable to detect the road network is disconnected from a neighbouring road network constructed for the self-driving vehicle; and in response to detecting the neighbouring road network, operate the self-driving vehicle to autonomously navigate between the road network and the neighbouring road network.

### BRIEF DESCRIPTION OF THE DRAWINGS

A preferred embodiment of the present invention will now be described in detail with reference to the drawings, in which:

FIG. 1 is a diagram of a system of one or more self-driving vehicles, according to at least one embodiment;

FIG. 2 is a block diagram of a self-driving vehicle, according to at least one embodiment;

FIG. 3 is another block diagram of a self-driving vehicle, according to at least one embodiment;

FIG. 4 is a flow diagram depicting a method for interpreting navigation features for constructing a road network for a self-driving vehicle, according to at least one embodiment;

FIGS. 5A and 5B are illustrations of an electronic map, according to at least one embodiment;

FIG. 6 is an illustration of an electronic map with a navigable path for a self-driving vehicle, according to at least one embodiment;

FIG. 7 is an interface for receiving one or more path segments of a navigable path, according to at least one embodiment;

FIG. 8A is an interface for receiving one or more intersections of a navigable path, according to at least one embodiment;

FIG. 8B is an interface for receiving one or more intersection characteristics of an intersection, according to at least one embodiment;

FIG. 9A is an interface for receiving one or more endpoints of a navigable path, according to at least one embodiment;

FIG. 9B is an interface for receiving one or more endpoint characteristics of an endpoint, according to at least one embodiment;

FIG. 10 is an interface for receiving one or more spaces of a navigable path, according to at least one embodiment;

FIGS. 11A to 11D are illustrations of operational paths for a self-driving vehicle, according to at least one embodiment;

FIG. 12A is another illustration of operational paths for a self-driving vehicle, according to at least one embodiment;

FIG. 12B is another illustration of operational paths for another self-driving vehicle, according to at least one embodiment;

FIG. 13 is an illustration of a road network constructed with operational paths for a self-driving vehicle, according to at least one embodiment; and

FIG. 14 is an illustration of neighbouring road networks in an environment, according to at least one embodiment.

The drawings, described below, are provided for purposes of illustration, and not of limitation, of the aspects and features of various examples of embodiments described herein. For simplicity and clarity of illustration, elements shown in the drawings have not necessarily been drawn to scale. The dimensions of some of the elements may be exaggerated relative to other elements for clarity. It will be appreciated that for simplicity and clarity of illustration, where considered appropriate, reference numerals may be repeated among the drawings to indicate corresponding or analogous elements or steps.

### DESCRIPTION OF EXEMPLARY EMBODIMENTS

Self-driving vehicles represent significant advantages when used as material transport vehicles within an industrial facility. A self-driving vehicle can autonomously navigate a facility based on a road network, also referred to as a graph, that is configured for that particular self-driving vehicle. The road network encodes information about the facility and the desired navigation behaviour in properties that the self-driving vehicle can use to navigate the facility appropriately. For example, the road network can include features such as, but not limited to, paths that the self-driving vehicle can navigate, rules constraining how the self-driving vehicle navigates such paths, and rules constraining how the self-driving vehicle behaves at certain features in the facility. However, the process of commissioning a self-driving vehicle (i.e., generating the road network) typically requires a significant amount of human time and expertise.

For example, current technology for commissioning a self-driving vehicle requires each detail of the road network to be manually specified by a human, including, for example, each path, intersection, endpoint, free space, and obstacle, as well as each applicable characteristic, constraint, and/or other feature of each path, intersection, endpoint, free space, and obstacle. Given the complexity of many facilities in which self-driving vehicles operate and the precision that is often required in self-driving vehicle missions, manually generating such road networks is highly time and labor intensive.

Accordingly, there is a need for improved systems and methods that allow a user to provide minimal inputs, such as simply specifying a navigable path and a navigation constraint for the environment, for generating the road network. The described systems and methods enable automatic construction of the road network without requiring the user to specify every detail of the road network.

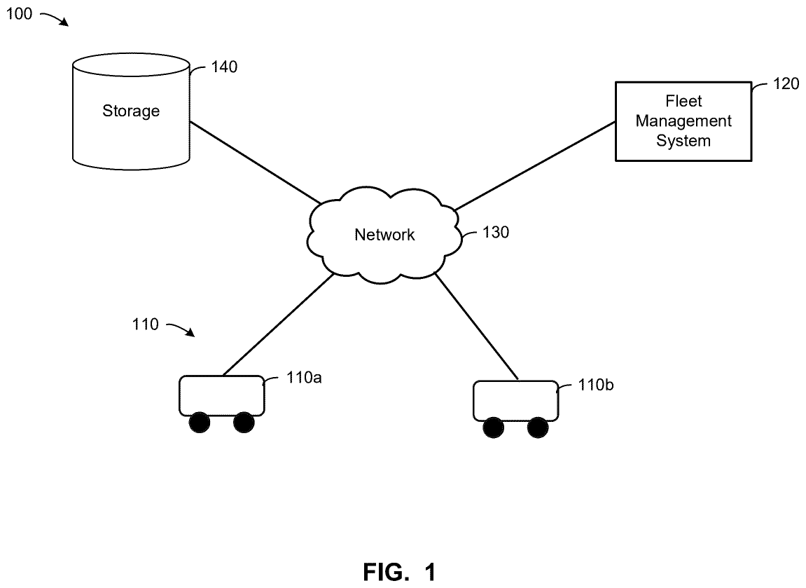

Referring to FIG. 1, shown therein is a system 100 of one or more self-driving vehicles 110, according to at least one embodiment. The system 100 can include one or more self-driving vehicles 110, a fleet management system 120, a network 130, and a system storage component 140. While FIG. 1 shows the system 100 having two self-driving vehicles 110a and 110b for illustrative purposes, the system 100 can include one or more self-driving vehicles 110.

According to some embodiments, a fleet management system 120 may be used to provide a mission to a self-driving vehicle 110. The fleet management system 120 has a processor, memory, and a communication interface (not shown) for communicating with the network 130. The fleet management system 120 uses the memory to store computer programs that are executable by the processor (e.g. using the memory) so that the fleet management system 120 can communicate information with other systems, and communicate with one or more self-driving vehicles 110. In some embodiments, the fleet management system 120 can also generate missions for the self-driving vehicles 110. The fleet management system 120 can include a user interface (not shown) for allowing a user to provide inputs to the system 100. In some embodiments, the fleet management system 120 can include a display (not shown) for displaying information to the user.

Any or all of the self-driving vehicles 110 and the fleet management system 120 may communicate with the network 130 using known telecommunications protocols and methods. For example, each self-driving vehicle 110 and the fleet management system 120 may be equipped with a wireless communication interface to enable wireless communications according to a WiFi protocol (e.g. IEEE 802.11 protocol or similar).

According to some embodiments, the system storage component 140 can store information about the self-driving vehicles 110 as well as electronic maps of the environments (e.g., facilities) within which the self-driving vehicles 110 operate. Electronic maps can be stored in the system storage component 140 for subsequent retrieval by individual self-driving vehicles 110. Individual self-driving vehicles 110 can download electronic maps from the system storage component 140 via network 130.

Electronic maps can be human generated. For example, a CAD file can be imported and form the basis for an electronic map. In another example, an electronic map can be built by driving the self-driving vehicle 110 around the environment for the purpose of building an electronic map.

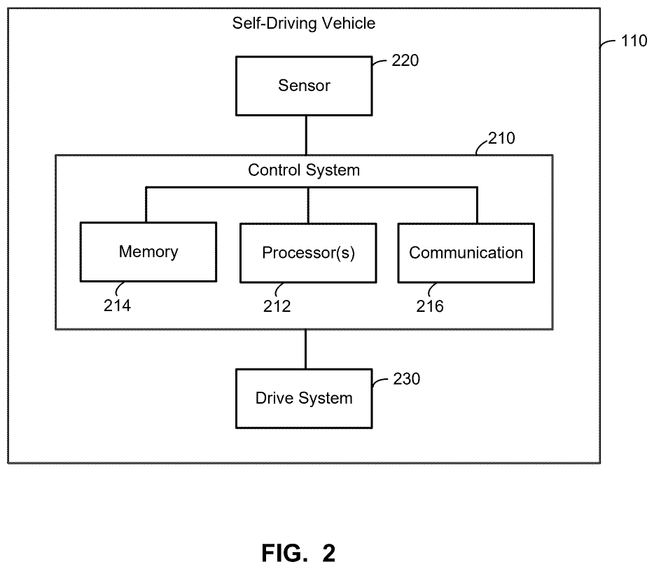

Referring to FIG. 2, shown therein is a block diagram of a self-driving vehicle 110, according to at least one embodiment. The self-driving vehicle 110 generally includes a control system 210 and a drive system 230.

The control system 210 can include a processor 212, memory 214, communication interface 216, and one or more sensors 220. The control system 210 enables the self-driving vehicle 110 to operate automatically and/or autonomously. The control system 210 can store an electronic map that represents the environment of the self-driving vehicle 110, such as a facility, in the memory 214.

According to some embodiments, the communication interface 216 can be a wireless transceiver for communicating with a wireless communications network (e.g. using an IEEE 802.11 protocol or similar).

One or more sensors 220 may be included in the self-driving vehicle 110 to obtain data about the environment of the self-driving vehicle 110. For example, according to some embodiments, the sensor 220 may be a LiDAR device (or other optical/laser, sonar, radar range-finding such as time-of-flight sensors). The sensor 220 may be optical sensors, such as video cameras and systems (e.g., stereo vision).

According to some embodiments, the self-driving vehicle 110 may receive a mission from a fleet management system 120 or other external computer system in communication with the self-driving vehicle 110 (e.g. in communication via the communication interface 216). The mission can include one or more waypoints or destination locations. Based on the waypoint or destination location contained in the mission, the self-driving vehicle 110, based on the control system 210, can autonomously navigate to the waypoint or destination location without receiving any other instructions from an external system. For example, the control system 210, along with the sensors 220, enable the self-driving vehicle 110 to navigate without any additional navigational aids such as navigational targets, magnetic strips, or paint/tape traces installed in the environment in order to guide the self-driving vehicle 110.

For example, the control system 210 may plan a path for the self-driving vehicle 110 based on a destination location and the location of the self-driving vehicle 110. Based on the planned path, the control system 210 may control the drive system 230 to direct the self-driving vehicle 110 along the planned path. As the self-driving vehicle 110 is driven along the planned path, the sensors 220 may update the control system 210 with new images of the environment of the self-driving vehicle 110, thereby tracking the progress of the self-driving vehicle 110 along the planned path and updating the location of the self-driving vehicle 110.

Since the control system 210 receives updated images of the environment of the self-driving vehicle 110, and since the control system 210 is able to autonomously plan the self-driving vehicle's path and control the drive system 230, the control system 210 is able to determine when there is an obstacle in the self-driving vehicle's path, plan a new path around the obstacle, and then drive the self-driving vehicle 110 around the obstacle according to the new path.

The positions of the components 210, 212, 214, 216, 220, and 230 of the self-driving vehicle 110 are shown for illustrative purposes and are not limited to the positions shown. Other configurations of the components 210, 212, 214, 216, 220, and 230 are possible.

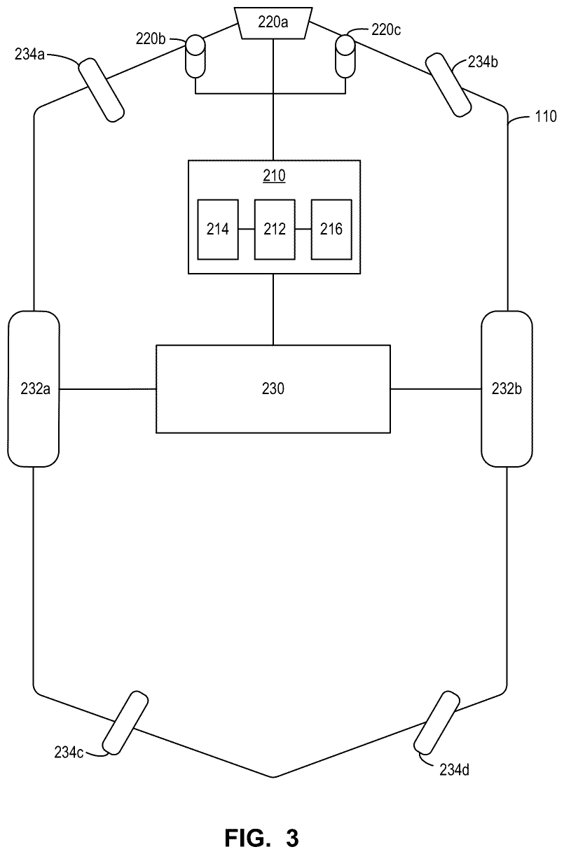

Referring to FIG. 3, there is shown a block diagram of a self-driving vehicle 110, according to at least one embodiment. The drive system 230 includes a motor and/or brakes connected to drive wheels 232a and 232b for driving the self-driving vehicle 110. According to some embodiments, the motor may be an electric motor, a combustion engine, or a combination/hybrid thereof. According to some embodiments, there may be one motor per drive wheel, for example, one for drive wheel 232a and one for drive wheel 232b. Depending on the particular embodiment, the drive system 230 may also include control interfaces that can be used for controlling the drive system 230. For example, the drive system 230 may be controlled to drive the drive wheel 232a at a different speed than the drive wheel 232b in order to turn the self-driving vehicle 110. Different embodiments may use different numbers of drive wheels, such as two, three, four, etc.

According to some embodiments, additional wheels 234 may be included (as shown in FIG. 3, the wheels 234a, 234b, 234c, and 234d may be collectively referred to as the wheels 234). Any or all of the additional wheels 234 may be wheels that are capable of allowing the self-driving vehicle 110 to turn, such as castors, omni-directional wheels, and mecanum wheels.

According to some embodiments, the sensors 220 (as shown in FIG. 3, the sensors 220a, 220b, and 220c may be collectively referred to as the sensors 220) may be optical sensors arranged in a manner to provide three-dimensional (e.g. binocular or RGB-D) imaging.

The positions of the components 210, 212, 214, 216, 220, 230, 232, and 234 of the self-driving vehicle 110 are shown for illustrative purposes and are not limited to the shown positions. Other configurations of the components 210, 212, 214, 216, 220, 230, 232, and 234 are possible.

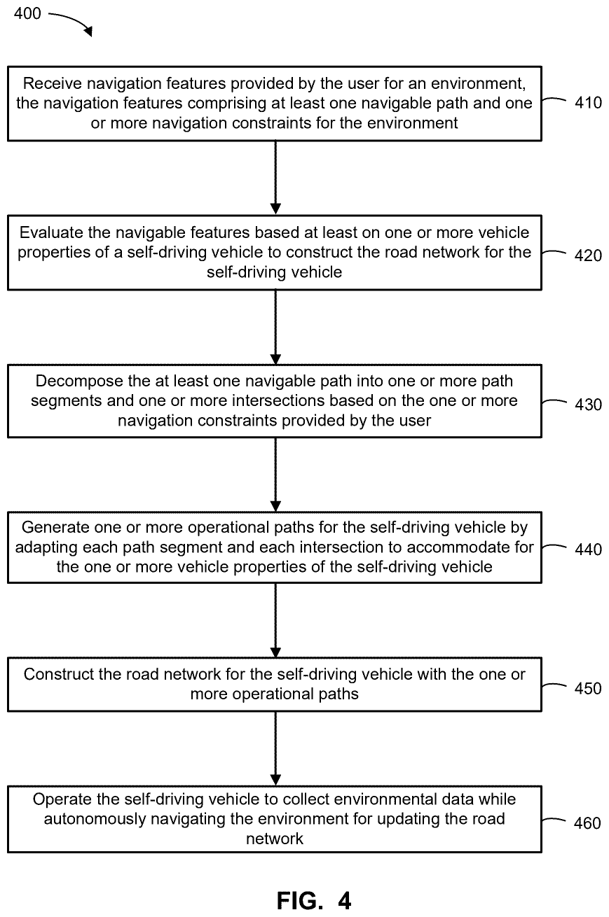

Referring now to FIG. 4, shown therein is a method 400 for interpreting navigation features provided by a user for constructing a road network autonomously navigable for at least one self-driving vehicle 110.

The method 400 begins at step 410, when the system 100 receives the navigation features provided by the user for an environment. The navigation features include at least one navigable path and one or more navigation constraints for the environment. The system 100 can receive the navigation features provided by the user via any suitable interface, such as a user interface of fleet management system 120.

The navigation constraints for the environment can represent one or more features and/or characteristics of the environment that can impact the self-driving vehicle's ability to navigate the environment. According to some embodiments, the navigation constraints for the environment can include walls, doors, terrain, and/or other obstacles of the environment. In some embodiments, the navigation constraints can be represented visually, such as in an environment blueprint, layout, map, simulation, and/or illustration. According to some embodiments, the environment can be a facility.

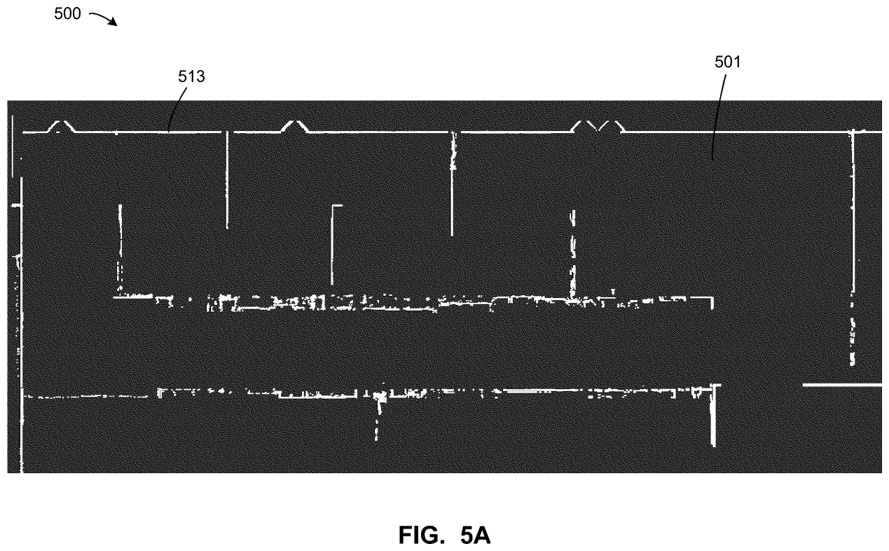

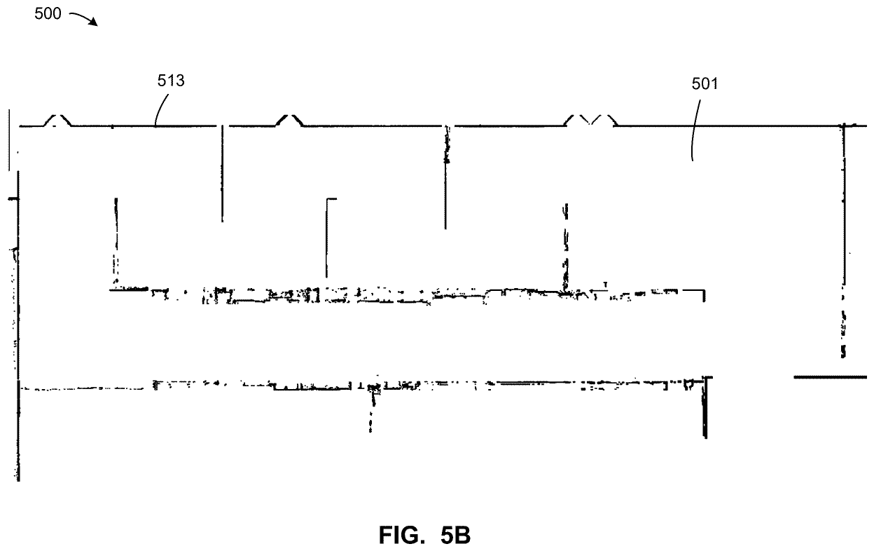

Referring to FIG. 5A, shown therein is an example electronic map 500 of an environment 501. Referring to FIG. 5B, shown therein is a black-and-white representation of the electronic map 500 for illustrative purposes. In the illustrated example, the environment 501 is a facility. The facility can be any place with a particular purpose. Example facilities include, but are not limited to, manufacturing plants, warehouses, offices, hospitals, hotels, and restaurants. The electronic map 500 can be displayed on any suitable display, such as a display of fleet management system 120. In some embodiments, the electronic map 500 can be stored on the system storage component 140 and/or memory 214. In some embodiments, the electronic map 500 can be generated based on sensor data collected by the self-driving vehicle 110.

As shown, the electronic map 500 can include various navigation constraints. For example, the environment 501 can have a number of obstacles 513, around which the self-driving vehicle 110 may need to navigate. Obstacles 513 can be permanent objects, such as walls or pillars. Obstacles 513 can also be temporary or transient objects, such as carts, crates, bins, and pallets. The self-driving vehicle 110 may need to navigate around the obstacles 513 in order to complete its mission.

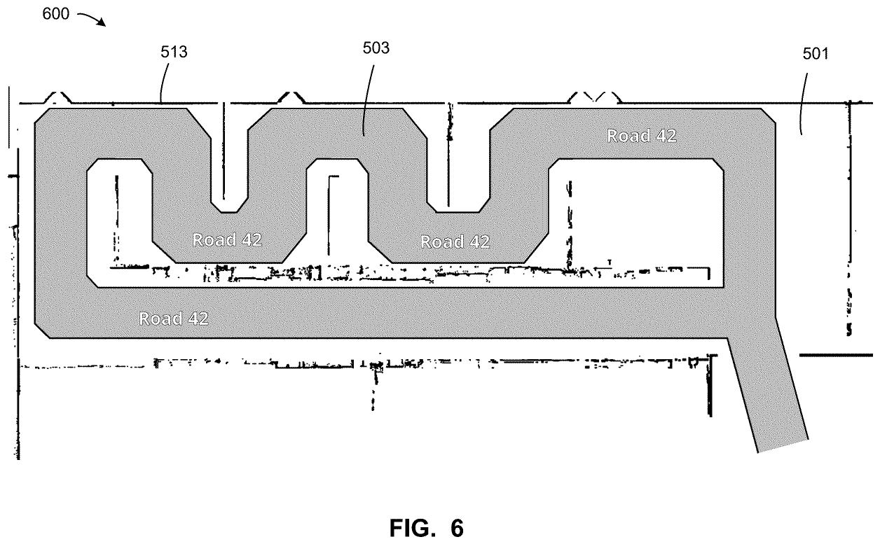

At least one navigable path includes a path along which the self-driving vehicle 110 can navigate through the environment. Referring now to FIG. 6, shown therein is an example electronic map 600 of the environment 501 with a navigable path 503 provided by the user. As shown, the navigable path 503 resembles a roadway or a pathway through the environment 501.

The navigable path 503 can include one or more path segments, intersections, endpoints, and/or spaces. In some embodiments, the system 100 can receive the navigable path 503 provided by the user in the form of one or more path segments, intersections, endpoints, and/or spaces. In some embodiments, the system 100 can automatically generate one or more path segments, intersections, endpoints, and/or spaces of the navigable path 503 based on other features of the navigable path 503 provided by the user. For example, if the user provides a navigable path 503 with two intersecting path segments, the system 100 can automatically generate an intersection at the intersection point of the two path segments.

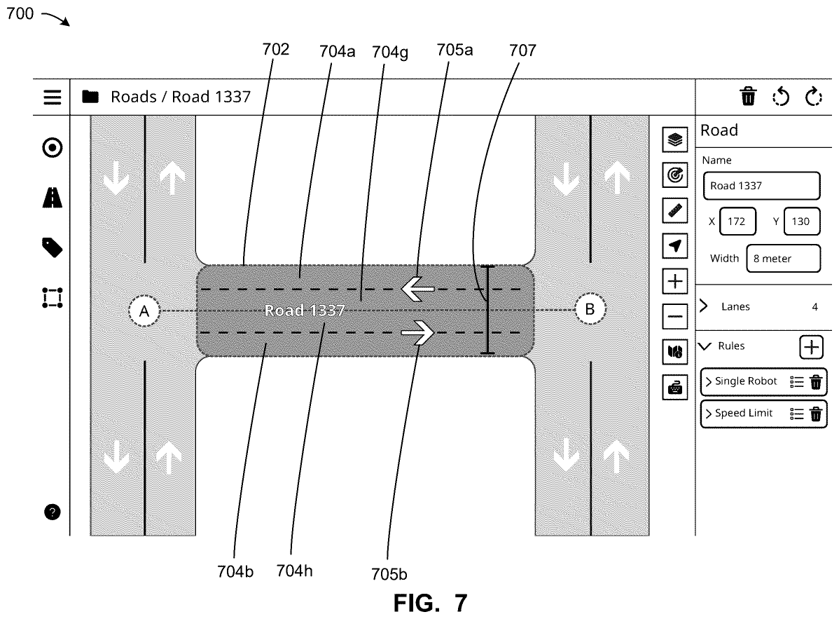

Referring now to FIG. 7, shown therein is an example interface 700 via which the system 100 can receive one or more path segments 702, according to at least one embodiment. As shown, the path segment 702 resembles a road or path along which the self-driving vehicle 110 can navigate. The illustrated example shows a straight path segment 702. However, other types (e.g., curved) of path segments 702 are possible.

Each path segment 702 can have one or more path characteristics. Path characteristics can include, for example, path width, number of lanes, directionality, navigation style, orientation, and/or path rules. In some embodiments, the user can provide one or more of the path characteristics. In some embodiments, the system 100 can automatically generate one or more default path characteristics if not provided by the user.

Each path segment 702 can have a width 707. As shown, the width 707 can be defined by the distance between each side of the path segment 702 in a direction generally perpendicular to the direction in which the path segment 702 extends.

Each path segment 702 can include one or more lanes 704. For example, each path segment 702 can include one lane, two lanes, three lanes, or four lanes. In the illustrated example, the path segment 702 includes four lanes 704a, 704b, 704g, and 704h. In some embodiments, the path segment 702 can include more than four lanes. The width of each lane 704 of a path segment 702 can be evenly distributed based on the path segment's width 707.

Each lane 704 of the path segment 702 can have a directionality 705. The directionality 705 can restrict the self-driving vehicle 110 to travelling in only one direction along the path segment 702, or can allow the self-driving vehicle 110 to travel in either direction along the path segment 702 (i.e., bidirectional). In the illustrated example, lanes 704b and 704h have directionality 705b from point A to point B, while lanes 704a and 704g have the opposite directionality 705a, from point B to point A. In some embodiments, the directionality 705 of a lane 704 relative to the directionality 705 of an adjacent lane 704 determines whether lane changing between the adjacent lanes 704 is permitted. For example, where adjacent lanes 704 have the same directionality 705, lane changing can be permitted between the adjacent lanes 704. As another example, where adjacent lanes 704 have opposite directionality 705, lane changing may not be permitted between the adjacent lanes 704. In the illustrated example, adjacent lanes 704a and 704g have the same directionality 705a, and accordingly, lane changing would be permitted between these lines, while adjacent lanes 704g and 704h have opposite directionalities 705a and 705b, and accordingly, lane changing would not be permitted between these lanes.

Each lane 704 of a path segment 702 can have a navigation style. The navigation style impacts the navigation behaviour of the self-driving vehicle 110 and represents how tightly the self-driving vehicle 110 adheres to the centerline of the lane 704. For example, the self-driving vehicle 110 may need to deviate from the centerline to circumvent an obstacle 513 in the lane 704. The navigation style can range from “relaxed” to “tight” and can also impact the self-driving vehicle's patience within the lane 704. The self-driving vehicle's patience can indicate how long the self-driving vehicle 110 should wait (e.g., 5 seconds, 1 minute, forever etc.) when encountering an obstacle 513 on its path before attempting to replan its route. A self-driving vehicle 110 with lower patience can quickly try to navigate around an obstacle 513 by replanning its route. A self-driving vehicle 110 with higher patience can wait for a longer period for the obstacle 513 to be removed from its path, or can eventually replan its route to navigate around the obstacle 513 if the obstacle 513 is not removed.

A relaxed navigation style allows the self-driving vehicle 110 to have more flexibility within the entire width of the lane 704 to navigate around an obstacle 513. A relaxed navigation style can have dynamic patience, meaning the user does not need to specify how long the self-driving vehicle 110 should wait before replanning its route when faced with an obstacle 513 on its path. Instead, the self-driving vehicle 110 can adjust its patience settings (e.g., more patient when closer to the “tight” end of the navigation style range and less patient when closer to the “relaxed” end of the navigation style range), allowing the self-driving vehicle 110 replan earlier, resulting in a smoother deviation around an obstacle 513 based on available space within a lane 704. That is, dynamic patience can allow the self-driving vehicle 110 to anticipate obstacles 513 in the lane 704 earlier.

A tight navigation style causes the self-driving vehicle 110 to follow the lane's centerline, such that the self-driving vehicle 110 can become blocked if there is an obstacle 513 along the lane's centerline. A tight navigation style can have controlled patience, meaning the user can specify a delay characteristic corresponding to how long the self-driving vehicle 110 should wait before replanning its route and navigating around an obstacle 513. The delay characteristic can range from immediate to indefinite. For example, the user can specify whether the self-driving vehicle 110 should wait forever before replanning (e.g., requiring user intervention to replan) or wait for a specified amount of time before attempting to replan.

A navigation style that falls between relaxed and tight can include moderate centerline adherence by prioritizing the self-driving vehicle's accuracy over speed. For example, the self-driving vehicle 110 can wait for a longer period before deciding to navigate around an obstacle 513, which can include reaching a closer distance to the obstacle 513 before attempting to plan around it.

In some embodiments, the user can specify the self-driving vehicle's patience and/or delay characteristic. In some embodiments, the system 100 can automatically determine the self-driving vehicle's patience and/or delay characteristic when not provided by the user, based on, for example, the navigation style.

Each lane 704 of a path segment 702 can have an orientation. The orientation represents the direction that the self-driving vehicle 110 should face while traveling along the path segment 702. For example, the self-driving vehicle 110 can face forwards relative to the direction of travel, or backwards relative to the direction of travel. In some embodiments, the orientation can be automatic such that the self-driving vehicle 110 can automatically adjust its orientation depending on the circumstances (e.g., the environment 501, its mission etc.).

Each lane 704 of the path segment 702 can have one or more rules. An assumed cost rule can relate to the path planning process for a self-driving vehicle 110, allowing the self-driving vehicle 110 to plan through areas that initially appear to be blocked by an obstacle 513. For example, the assumed cost rule can allow a self-driving vehicle 110 to navigate along a portion of the navigable path 503 that appears to be blocked (e.g., ignoring obstacles 513), or can restrict a self-driving vehicle 110 from navigating along a portion of the navigable path 503 that appears to be clear (e.g., based on sensor data).

A safety rule can allow the self-driving vehicle 110 to adjust the behaviour of its safety features for a portion of the navigable path 503. For example, the self-driving vehicle 110 has a fieldset (i.e., a 2D polygon that specifies the space around the self-driving vehicle 110 in which contact with an obstacle 513 would cause a safety stop resulting in the self-driving vehicle 110 seizing motion) and a footprint (i.e., fieldset plus a buffer space to allow the self-driving vehicle 110 to navigate around obstacles 513 and avoid safety stops), which can be adjusted based on a safety rule. For example, in a narrow mode, the fieldset and/or footprint can be reduced to a minimum value, allowing the self-driving vehicle 110 to navigate in a narrow area. In some embodiments, the safety rule can include optional settings such as speed limits (e.g., reduced speed limit when in a narrow mode), and/or safety indicators (e.g., emitting visual and/or audio signals indicating the self-driving vehicle 110 is operating in a narrow mode).

A speed limit rule can enforce a maximum speed at which the self-driving vehicle 110 can travel along the path segment 702.

A single vehicle rule can limit a lane 704 and/or path segment 702 to allowing only one self-driving vehicle 110 on the lane 704 and/or path segment 702 at any moment in time. This rule can be advantageous when the lane 704 and/or path segment 702 isn't wide enough for more than one self-driving vehicle 110.

Each lane 704 of the path segment 702 can be assigned to a team. One or more self-driving vehicles 110 can be assigned to a team. Each team can have access to different road networks and/or different rules, characteristics, and/or features of a navigable path 503. Each team can be assigned different missions to perform. Teams allow the user to make custom configurations for different self-driving vehicles 110. For example, one team may be allowed to navigate a specific portion of the navigable path 503 while another team may not be allowed to do so.

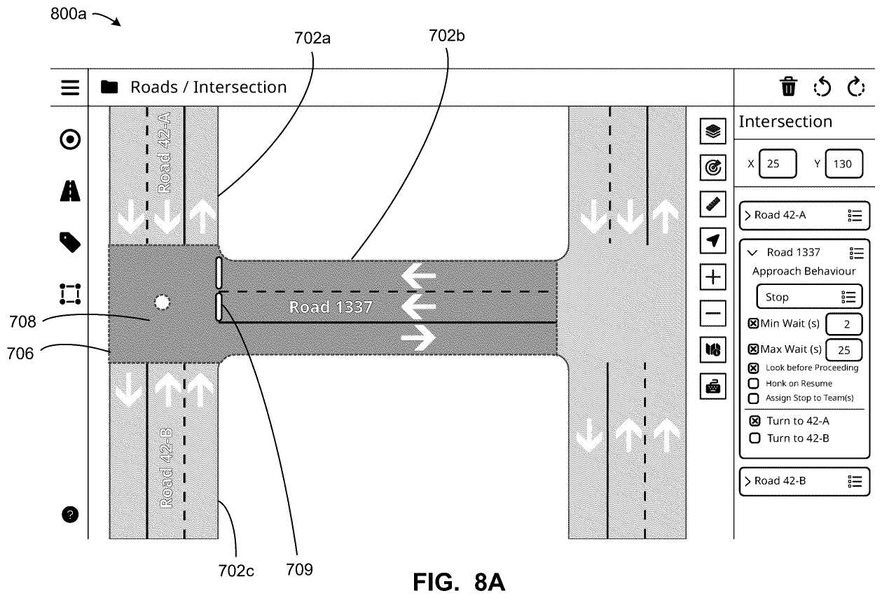

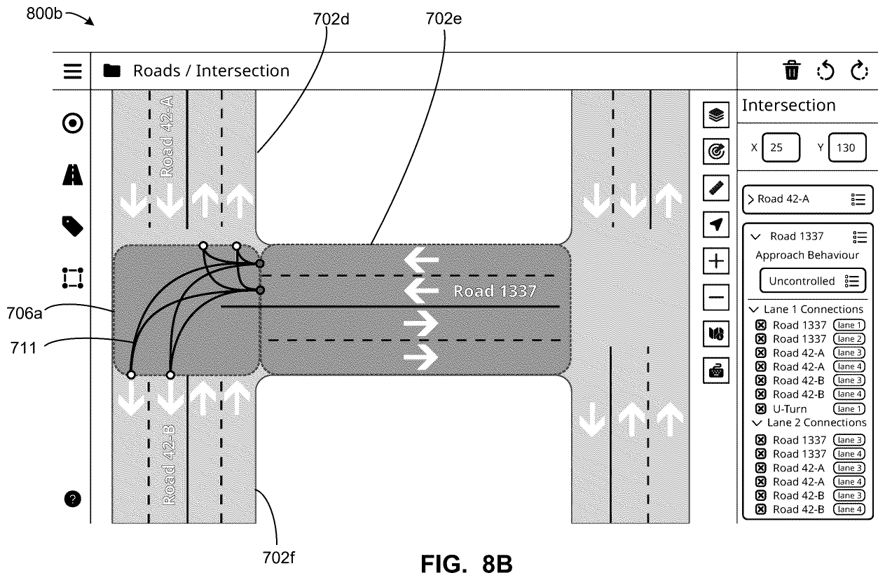

Referring now to FIG. 8A, shown therein is an example interface 800a via which the system 100 can receive one or more intersections 706, according to at least one embodiment. The intersection 706 can represent a point at which two or more path segments 702 intersect. In the illustrated example, intersection 706 has three connected path segments 702a to 702c. In some embodiments, the system 100 can automatically generate an intersection 706 when two intersecting path segments 702 are provided. Various intersection layouts are possible, including but not limited to, a crossroad, a skewed crossroad, a T-intersection, a Y-intersection, a join, a staggered intersection, a roundabout, or a pinch intersection (e.g., where a path segment 702 with 2 lanes becomes a path segment 702 with 1 lane). Each intersection 706 can have one or more intersection characteristics. In some embodiments, the user can provide one or more of the intersection characteristics. In some embodiments, the system 100 can automatically generate default intersection characteristics when not provided by the user.

Each path segment 702 connected to the intersection 706 can have an approach behaviour 709, which defines how a self-driving vehicle 110 behaves when approaching the intersection 706. The system 100 can apply the approach behaviour 709 to all lanes 704 of the path segment 702 with a directionality 705 that moves towards the intersection 706. Possible approach behaviours 709 can include, but are not limited to, uncontrolled, stop, yield, or signaled. In some embodiments, the approach behavior 709 can be represented visually. In the illustrated example, a stop approach behaviour 709 is illustrated with red lines in the appropriate lanes 704.

An uncontrolled approach behaviour 709 allows the self-driving vehicle 110 to proceed through the intersection 706 at its set speed, without stopping and/or yielding. In some embodiments, an uncontrolled approach behaviour 709 does not enforce any wait times or additional actions (e.g., honking).

A stop approach behaviour 709 causes the self-driving vehicle 110 to stop before entering the intersection 706 and then proceeding through the intersection 706. In some embodiments, a minimum wait can be provided. In some embodiments, a stop approach behaviour 709 can require the self-driving vehicle 110 to check one or more areas of the intersection 706 (e.g., via sensors 220) before entering the intersection 706. For example, the self-driving vehicle 110 can be required to check an interior portion 708 of the intersection 706, as well as each path segment 702 connected to the intersection 706. In such embodiments, an optional minimum or maximum wait time can be specified. In some embodiments, a stop approach behaviour 709 can cause a self-driving vehicle 110 to generate an audible noise (e.g., honk) before entering the intersection 706. This can provide an indication to other self-driving vehicles 110 or persons nearby or approaching the intersection 706 that the intersection 706 is soon to have traffic and/or activity.

A yield approach behaviour 709 causes the self-driving vehicle 110 to yield to other self-driving vehicles 110 at the intersection 706 before entering the intersection 706 and proceeding through the intersection 706. A yield approach behaviour 709 requires the self-driving vehicle 110 to check one or more areas of the intersection 706 (e.g., via sensors 220) before entering the intersection 706. For example, the self-driving vehicle 110 can be required to check an interior portion 708 of the intersection 706, as well as each path segment 702 connected to the intersection 706. If the one or more areas of the intersection 706 are clear to proceed, the self-driving vehicle 110 can enter the intersection 706 and proceed through the intersection 706 without waiting. Minimum and/or maximum wait times can be specified to constrain how long the self-driving vehicle 110 should wait when checking for traffic and/or activity in the intersection 706. In some embodiments, a yield approach behaviour 709 can cause a self-driving vehicle 110 to generate an audible noise (e.g., honk) before entering the intersection 706. This can provide an indication to other self-driving vehicles 110 or persons nearby or approaching the intersection 706 that the intersection 706 is soon to have traffic and/or activity.

A signaled approach behaviour 709 causes the self-driving vehicle 110 to obey a signal located at the intersection 706. The signal can include, for example, a traffic light, a barrier arm, a barrier gate, an audible signal, a digital signal, and/or any other appropriate signal mechanism. In some embodiments, the signal is communicated using an application programming interface (API). The self-driving vehicle 110 can observe the signal (e.g., via sensors 220) and proceed to enter the intersection 706 and proceed through the intersection 706 once signaled to do so.

Each intersection 706 can have one or more intersection connections. Referring now to FIG. 8B, shown therein is an example interface 800b with intersection connections 711 in intersection 706a, according to at least one embodiment. The intersection connections 711 can be defined by one or more turn controls of each path segment 702 connected to the intersection 706. That is, each path segment 702 connected to an intersection 706 can have one or more turn controls that define how the self-driving vehicle 110 can proceed through the intersection 706. The turn controls can include, for example, right turn, left turn, proceeding straight, and/or U-turn. The available turn controls for a given intersection 706 will depend on the intersection layout (i.e., the number and orientation of path segments 702 that are connected to the intersection 706). In the illustrated example, the intersection connections 711 are provided based on the turn controls for one lane of path segment 702e in relation to one lane of path segment 702d and one lane of path segment 702f. In some embodiments, the user can provide one or more of the intersection connections 711. In some embodiments, the system 100 can automatically generate one or more intersection connections 711 when not provided by the user.

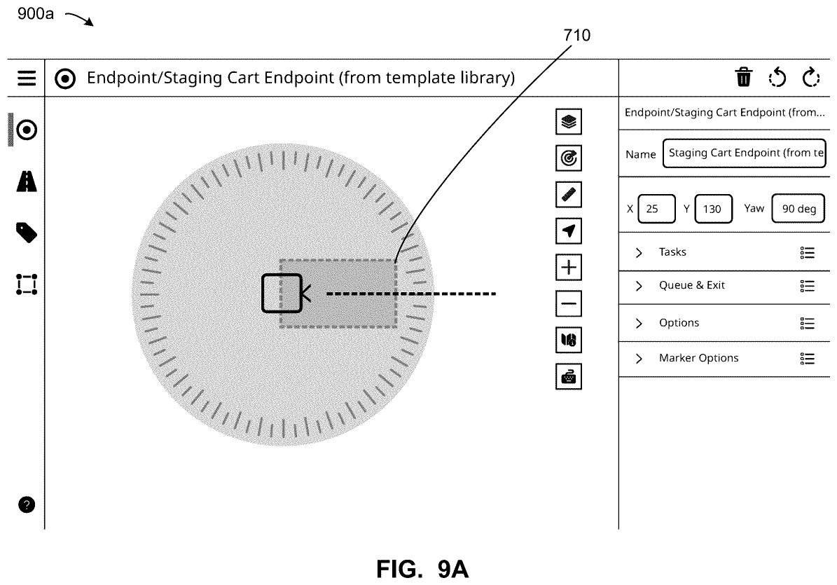

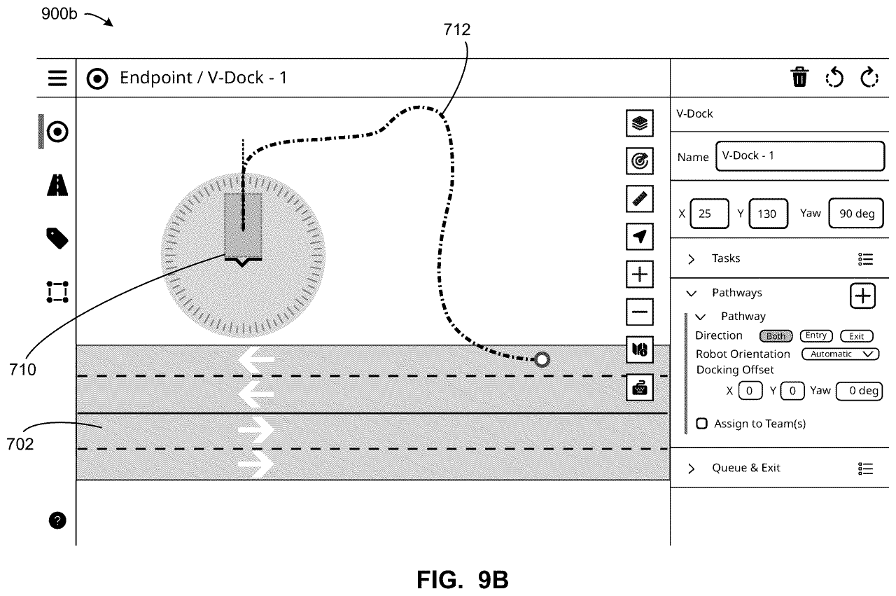

Referring now to FIG. 9A, shown therein is an example interface 900a via which the system 100 can receive one or more endpoints 710, according to at least one embodiment. An endpoint 710 can represent any point in the environment 501 where a self-driving vehicle 110 performs a particular task. Such tasks can include, for example, picking up, dropping off, and/or moving material and/or carts, docking, parking, and/or charging. Each endpoint 710 can have one or more endpoint characteristics. In some embodiments, the user can provide one or more of the endpoint characteristics. In some embodiments, the system 100 can automatically generate one or more endpoint characteristics when not provided by the user.

Each endpoint 710 can have an endpoint type that is defined by the task to be performed at the endpoint 710. In some embodiments, the self-driving vehicle 110 can perform more than one task at the endpoint 710. In some embodiments, the endpoint 710 defines a sequence of tasks to be performed in a particular order. In some embodiments, the system 100 automatically assigns one or more tasks to be performed at the endpoint 710 based on the specified endpoint type.

Example endpoint types include, but are not limited to, material transfer stations, charging stations, pallets, parking stations, carts, tuggers, docking stations, waypoints, and custom endpoints. At a material transfer station endpoint 710, the self-driving vehicle 110 can pick-up, drop-off, and/or move one or more materials. At a charging station endpoint 710, the self-driving vehicle 110 can position itself appropriately to connect to a charging port to charge a power source of the self-driving vehicle 110. At a pallet endpoint 710, the self-driving vehicle 110 can pick-up and/or drop-off one or more pallets. At a parking station endpoint 710, the self-driving vehicle 110 can park at a specified location of the endpoint 710. At a cart endpoint 710, the self-driving vehicle 110 can pick-up and/or drop-off a cart. A cart can carry material to be transported within the environment 501. At a tugger endpoint 710, the self-driving vehicle 110 can align one or more tugger carts with a specified portion of the endpoint 710. At a docking station endpoint 710, the self-driving vehicle 110 can dock at a specified location of the endpoint 710, which can involve coupling to and/or otherwise engaging with equipment at the endpoint 710. A waypoint endpoint 710 can include any intermediate location at which the self-driving vehicle 110 executes one or more tasks (including waiting for a next task and/or route) for its mission. For example, a self-driving vehicle 110 can reach a waypoint endpoint 710, stop and wait for an instruction (e.g., from the fleet management system 120), and then continue its mission based on that instruction. At a custom endpoint 710, the user can specify a custom task or sequence of tasks that the self-driving vehicle 110 can perform at the endpoint 710.

In some embodiments, the system 100 can include an endpoints library. The endpoints library can be stored in the system storage component 140 and/or the memory 214. The endpoints library can include one or more endpoint templates with default settings for different endpoint types. The endpoints library can be particularly useful when an environment 501 has multiple instances of the same type of endpoint 710 (e.g., material transfer stations).

Each endpoint 710 can have one or more endpoint connections, which connects the endpoint 710 to a path segment 702. Referring to FIG. 9B, shown therein is an example interface 900b with an endpoint connection 712 that connects the endpoint 710 and the path segment 702, according to at least one embodiment. In some embodiments, the system 100 can automatically generate one or more endpoint connections 712 between an endpoint 710 and a path segment 702. For example, when an endpoint 710 is located near, but not in contact with, a path segment 702, the system 100 can automatically generate one or more endpoint connections 712 to connect the endpoint 710 to the path segment 702. In some embodiments, the user can provide the endpoint connections 712. In some embodiments, the endpoint connections 712 can include an entry connection and an exit connection. In some embodiments, a single endpoint connection 712 functions as both the entry connection and the exit connection. In some embodiments, the endpoint connection 712 is based on the type of endpoint 710. For example, some endpoint types may require the entry connection and/or the exit connection to be located at a certain position of the endpoint 710.

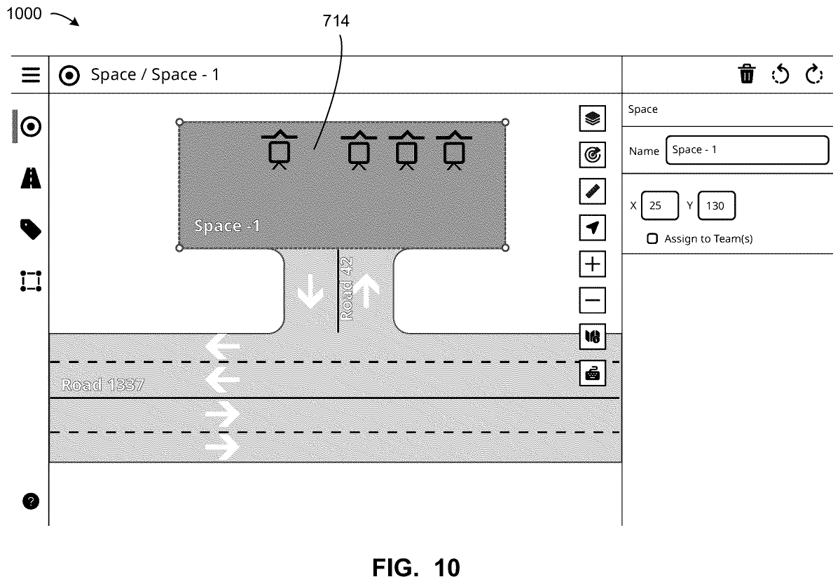

Referring now to FIG. 10, shown therein is an example interface 1000 via which the system 100 can receive a space 714, according to at least one embodiment. A space 714 can represent a portion of the navigable path 503 in which a self-driving vehicle 110 can navigate freely and use intelligent path finding to avoid obstacles.

Returning now to FIG. 4, at step 420, the system 100 evaluates the navigable features based at least on one or more vehicle properties of the self-driving vehicle 110 to construct the road network for the self-driving vehicle 110.

The self-driving vehicle 110 can have various vehicle properties. The vehicle properties can include any properties of the self-driving vehicle 110 that can impact the self-driving vehicle's ability to navigate an environment 501. The vehicle properties can include a vehicle footprint. The vehicle footprint can include, for example, the 2D dimensions (e.g., width and length) that define the shape of the self-driving vehicle 110 on a 2D plane. The footprint can depend on whether the self-driving vehicle 110 is carrying a payload. The vehicle properties can include properties related to maneuverability such as, for example, turn radius, steering ability, and acceleration/deceleration ability. Maneuverability properties can impact, for example, how well the self-driving vehicle 110 can turn, steer, change direction, start moving, and stop moving. The vehicle properties can include payload properties such as presence/absence of a payload. In some embodiments, whether or not the self-driving vehicle 110 is carrying a payload can impact other vehicle properties, such as the footprint and maneuverability properties. The vehicle properties can include linear and angular maximum forward and/or reversing driving speed, and linear and angular maximum acceleration and/or deceleration.

At step 430, the system 100 decomposes the at least one navigable path 503 into one or more path segments 702 and one or more intersections 706 based on the one or more navigation constraints provided by the user.

In some embodiments, the one or more path segments 702 and the one or more intersections 706 can be based on components of the navigable path 503 provided by the user or automatically generated by the system 100. For example, the one or more path segments 702 can include one or more path segments 702 provided by the user when providing the navigable path 503 or automatically generated by the system 100. As another example, the one or more intersections 706 can include one or more intersections 706 provided by the user when providing the navigable path 503 or automatically generated by the system 100.

In some embodiments, the system 100 can further decompose at least one navigable path 503 into one or more endpoints 710 and/or spaces 714. Such endpoints 710 and/or spaces 714 can include one or more endpoints 710 and/or spaces 714 provided by the user when providing the navigable path 503 or automatically generated by the system 100.

The system 100 can determine that the one or more path segments 702 and the one or more intersections 706 are compatible with the one or more navigation constraints provided by the user. That is, when decomposing at least one navigable path 503 into one or more path segments 702 and one or more intersections 706, the system 100 can determine that the path segments 702 and intersections 706 are appropriate in view of the navigation constraints. For example, the system 100 can determine that a path segment 702 may not be appropriate and compatible with the navigation constraints if the path segment 702 traverses through a wall (or any other physical, permanent obstacle 513) of the environment 501. As another example, the system 100 can determine that an intersection 706 may not be appropriate and compatible with the navigation constraints if the intersection 706 is positioned at a permanent obstacle 513 (e.g., a pillar) of the environment 501 that would create a safety hazard for the self-driving vehicle 110. As another example, the system 100 can determine that the path segments 702 and intersections 706 comply with any exclusion zones (e.g., one or more areas in the environment 501 in which the self-driving vehicle 110 should not enter) provided by the user. As a further example, the system 100 can determine that the path segments 702 and intersections 706 comply with other features provided by the user (e.g., directionality 705 of a lane 704).

In some embodiments, the system 100 can determine an intersection type of each of the one or more intersections 706. In some embodiments, the type of each intersection 706 can be based on the approach behaviour 709 of the path segments 702 connected to the intersection 706. For example, the system 100 can determine that an intersection 706 in which all connected path segments 702 have a stop approach behaviour 709 is an “all-way stop” type intersection 706. As another example, the system 100 can determine that a T-intersection 706 in which all connected path segments 702 have an uncontrolled approach behaviour 709 is an “uncontrolled” type intersection 706. As a further example, the system 100 can determine that an intersection 706 in which one connected path segment 702 has an uncontrolled approach behaviour 709 and another connected path segment 702 has a yield approach behaviour 709 is a “mixed” type intersection 706.

In some embodiments, the system 100 can automatically incorporate relevant navigation prompts at each intersection 706. In some embodiments, the relevant navigation prompts can be based on the intersection type. For example, the relevant navigation prompt for an all-way stop type intersection 706 can include “stop”. As another example, the relevant navigation prompts for a mixed type intersection 706 can include “yield” and “uncontrolled”. In some embodiments, the relevant navigation prompts can include other features of the relevant approach behaviours 709 related to the intersection type. For example, when the relevant navigation prompts include a “yield” prompt, the relevant navigation prompts can further include a “check” prompt, requiring the self-driving vehicle 110 to check one or more areas of the intersection 706 before proceeding. These relevant navigation prompts are provided as an example only, and any other relevant navigation prompt, including any of the additional features with respect to approach behaviours 709 and intersections 706 discussed herein, can be incorporated.

In some embodiments, the system 100 can determine one or more path characteristics for each path segment 702. As discussed herein, in some embodiments, the one or more path characteristics can be defined by the user or by the system 100 when not defined by the user. The system 100 can assign the one or more path characteristics to the corresponding path segment 702.

At step 440, the system 100 generates one or more operational paths for the self-driving vehicle 110 by adapting each path segment 702 and each intersection 706 to accommodate for the one or more vehicle properties of the self-driving vehicle 110.

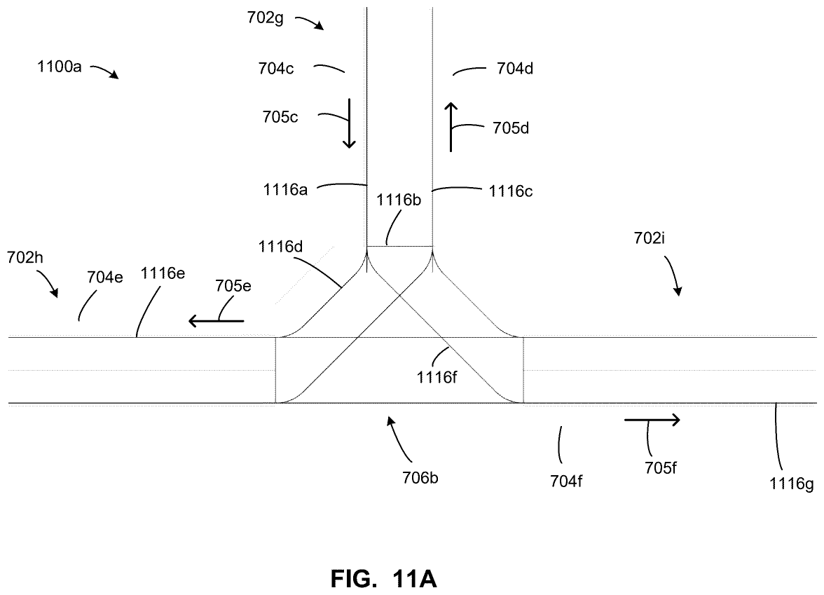

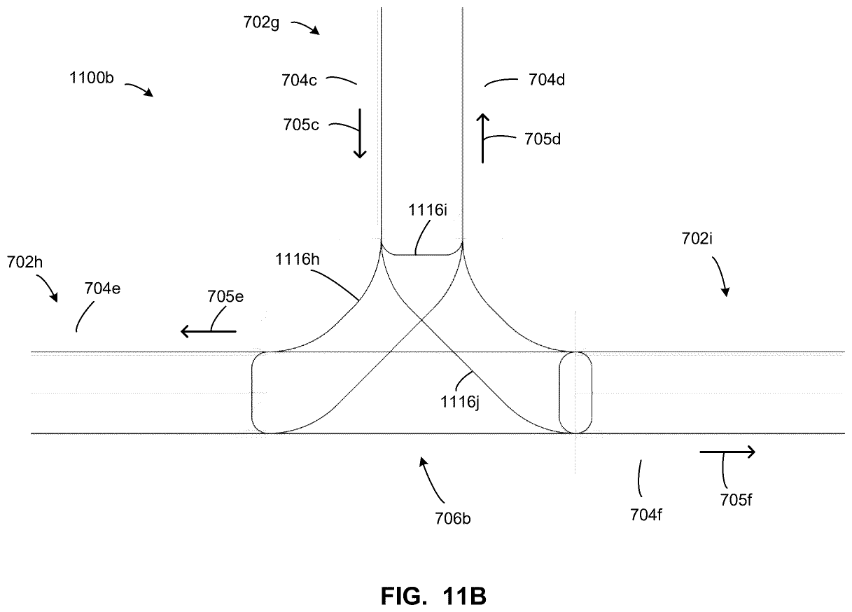

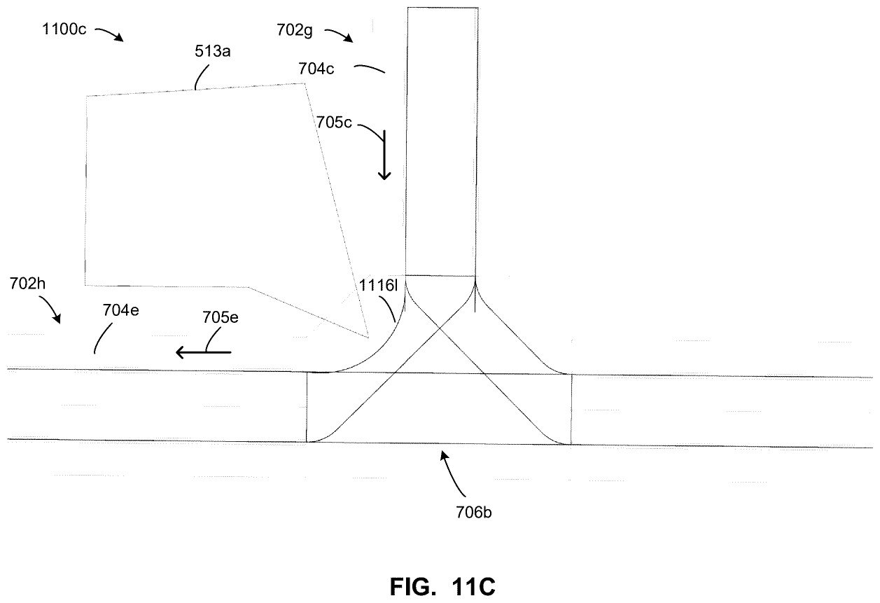

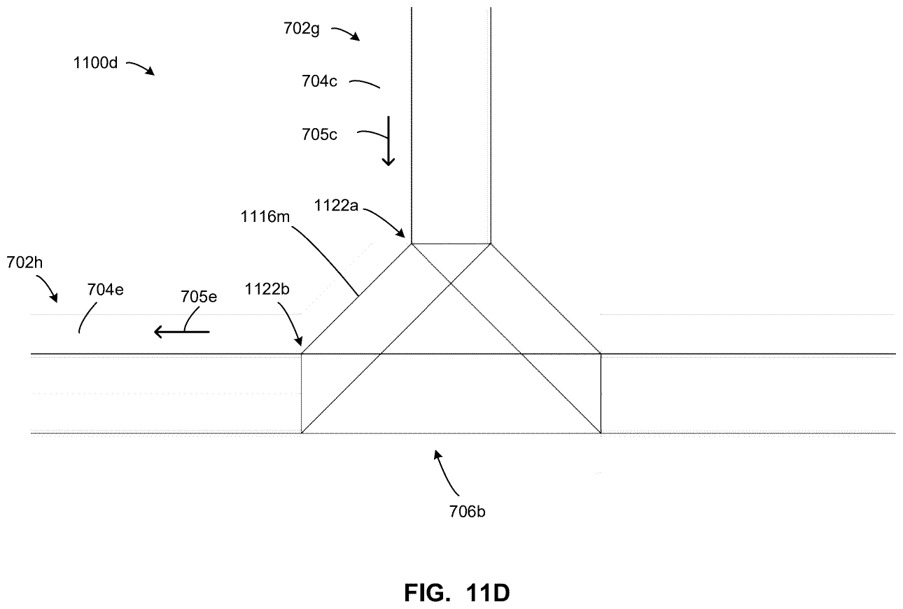

Referring now to FIG. 11A, shown therein is an example illustration 1100a of various operational paths 1116 for the self-driving vehicle 110. As shown, the intersection 706b includes three connected path segments 702g, 702h, and 702i. Each path segment 702g to 702i has two lanes 704. For ease of illustration, only operational paths 1116 with respect to lane 704c of path segment 702g will be described. However, it should be understood that similar operational paths 1116 are generated for each illustrated lane 704 of each path segment 702g to 702i. Operational path 1116a enables the self-driving vehicle 110 to navigate along lane 704c in direction 705c, towards intersection 706b. Operational path 1116b enables the self-driving vehicle 110 to perform a U-turn into lane 704d. Operational path 1116c enables the self-driving vehicle 110 to navigate along lane 704d in direction 705d. Operational path 1116d enables the self-driving vehicle 110 to navigate through intersection 706b towards lane 704e of path segment 702h. Operational path 1116e enables the self-driving vehicle 110 to navigate along lane 704e in direction 705e. Operational path 1116f enables the self-driving vehicle 110 to navigate through intersection 706b towards lane 704f of path segment 702i. Operational path 1116g enables the self-driving vehicle 110 to navigate along lane 704f in direction 705f. The self-driving vehicle 110 can use the operational paths 1116a to 1116g to navigate the intersection 706b and connected path segments 702g to 702i.

Referring now to FIG. 11B, shown therein is another example illustration 1100b of various operational paths 1116 for the self-driving vehicle 110. Illustration 1100b is similar to illustration 1100a, except that, as shown, the system 100 has adapted the operational paths 1116 to accommodate for one or more vehicle properties of the self-driving vehicle 110. That is, operational paths 1116 in illustration 1100a and illustration 1100b can be based on the same navigation features, but differ based on different vehicle properties of different self-driving vehicles 110. As shown in illustration 1100b, the shapes of operational paths 1116h, 1116i, and 1116j differ from the shapes of corresponding operational paths 1116d, 1116b, and 1116f, respectively, in order to optimize performance for different self-driving vehicles 110 with different vehicle properties. This is particularly evident when comparing, for example, U-turn operational path 1116b in illustration 1100a, which involves two 90 degree turns, and U-turn operational path 1116i in illustration 1100b, which involves two arced turns.

Referring now to FIG. 11C, shown therein is another example illustration 1100c of various operational paths 1116 for the self-driving vehicle 110. Illustration 1100c is similar to illustration 1100a, except that as shown, the environment 501 in illustration 1100c includes a protrusion 513a into the intersection 706b. In some embodiments, the system 100 evaluates, for each path segment 702 and intersection 706, whether the navigation constraints provided by the user are compatible with the vehicle properties of the self-driving vehicle 110. In response to determining that one or more of the vehicle properties is incompatible with one or more of the navigation constraints, the system 100 can adapt the path segment 702 and/or intersection 706 to accommodate the vehicle properties and the navigation constraints. In the illustrated example, based on the vehicle properties of the self-driving vehicle 110, the system 100 can generate operational path 1116l in order to avoid a collision with the protrusion 513a while navigating through the intersection 706b. For example, as shown, the operational path 1116l is generated to arc around the protrusion 513a. The relevant vehicle properties of the self-driving vehicle 110 in the illustrated example can include, for example, the footprint (e.g., dimensions) of the self-driving vehicle 110, turn radius, and whether or not the self-driving vehicle 110 is carrying a payload.

Referring now to FIG. 11D, shown therein is another example illustration 1100d of various operational paths 1116 for the self-driving vehicle 110. Illustration 1100d is similar to illustration 1100a, except that, as shown, the system 100 has adapted the operational paths 1116 to accommodate for one or more vehicle properties of the self-driving vehicle 110. For example, for some self-driving vehicles 110, it may be more efficient to turn in place and then continue navigating in a generally straight path, rather than navigating through the intersection 706 in an arc-shape path (e.g., like operational path 1116d in illustration 1100a). Rather, as shown in illustration 1100d, the self-driving vehicle 110 can turn in place at point 1122a and then proceed in a straight line along operational path 1116m, and then turn in place again at point 1122b before continuing in direction 705c along lane 704e.

In some embodiments, the system 100 can generate the one or more operational paths 1116 based on one or more intersection characteristics. For example, the system 100 can determine an intersection type for each intersection 706. The system 100 can determine one or more available operational movements for the self-driving vehicle 110 at the intersection type based on the vehicle properties of the self-driving vehicle 110. The system 100 can then generate the one or more operational paths 1116 to account for the one or more operational movements. In some embodiments, the intersection type can be based on one or more intersection characteristics discussed herein. For example, the intersection type can be based on the intersection layout, approach behaviour 709, intersection connections 711, and/or available turn controls. In some embodiments, the available operational movements can include an approach behaviour 709 (e.g., stop, yield etc.), an available turn control (e.g., turn right, turn left, U-turn, proceed straight etc.), and/or any other suitable operational movement.

In some embodiments, the one or more operational paths 1116 can be different for different self-driving vehicles 110, resulting in different road networks for each self-driving vehicle 110. That is, since the one or more operational paths 1116 are adapted to accommodate for the one or more vehicle properties of the self-driving vehicle 110, a user can input a single set of navigation features, from which the system 100 can generate different road networks for different self-driving vehicles 110. For example, in an embodiment with a first self-driving vehicle with a first set of vehicle properties and a second self-driving vehicle with a second set of vehicle properties that is different from the first set of vehicle properties, the system 100 can construct a first road network with operational paths that accommodate the first set of vehicle properties, and a second road network with operational paths that accommodate the second set of vehicle properties, where the first road network is different from the second road network.

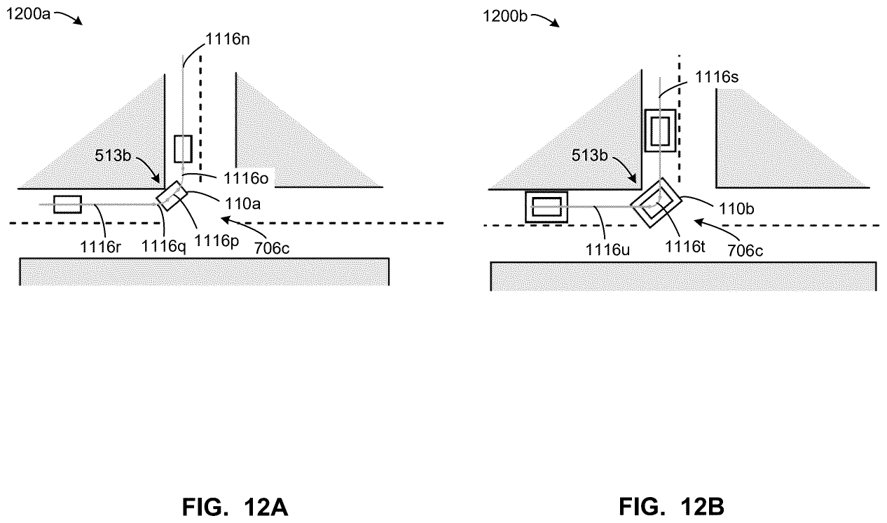

Referring now to FIG. 12A, shown therein is an example illustration 1200a of operational paths 1116 for self-driving vehicle 110a to navigate through intersection 706c and around obstacle 513b. As shown, there are five operational paths 1116n to 1116r. Operational path 1116n directs the self-driving vehicle 110a to approach the intersection 706c in a straight path. Operational path 1116o directs the self-driving vehicle 110a to make a first arced turn. Operational path 1116p directs the self-driving vehicle 110a to proceed straight through the intersection 706c. Operational path 1116q directs the self-driving vehicle 110a to make a second arced turn. Operational path 1116r directs the self-driving vehicle 110a to navigate away from the intersection 706c in a straight path. As shown, the operational paths 1116o to 1116q accommodate one or more vehicle properties (e.g., dimensions, payload, maneuverability) of the self-driving vehicle 110a in view of the environmental obstacle 513b (e.g., wall).

Referring now to FIG. 12B, shown therein is an example illustration 1200b of operational paths 1116 for self-driving vehicle 110b through intersection 706c and around obstacle 513c. The intersection 706c and environmental obstacle 513c in illustration 1200b are the same as those in illustration 1200a in FIG. 12A. The system 100 can generate the illustrated operational paths 1116s to 1116u based on the same navigation features as the operational paths 1116n to 1116r in FIG. 12A. As shown in FIG. 12B, the operational paths 1116s to 1116u differ from the operational paths 1116n to 1116r in FIG. 12A in order to accommodate for one or more vehicle properties of self-driving vehicles 110b and 110a, respectively. As shown in FIG. 12B, there are three operational paths 1116s to 1116u. Operational path 1116s directs the self-driving vehicle 110b to approach the intersection 706c in a straight path. Operational path 1116t directs the self-driving vehicle 110b to make an arced turn through the intersection 706c. Operational path 1116u directs the self-driving vehicle 110b to navigate away from the intersection 706c along a straight path. As shown, the operational paths 1116s to 1116u accommodate one or more vehicle properties (e.g., size, payload, maneuverability) of the self-driving vehicle 110b in view of the environmental obstacle 513b (e.g., wall).

In some embodiments, the system 100 can generate the one or more operational paths 1116 for the self-driving vehicle 110 to incorporate one or more endpoints 710 and/or spaces 714 of the navigable path 503. For example, in some embodiments, the system 100 can identify an endpoint 710 from the navigation features and generate the one or more operational paths 1116 to incorporate characteristics of the endpoint 710. For example, the system 100 can generate the one or more operational paths 1116 to incorporate an endpoint connection 712 between the endpoint 710 and a path segment 702.

Returning to FIG. 4, at step 450, the system 100 constructs the road network for the self-driving vehicle 110 with the one or more operational paths 1116.

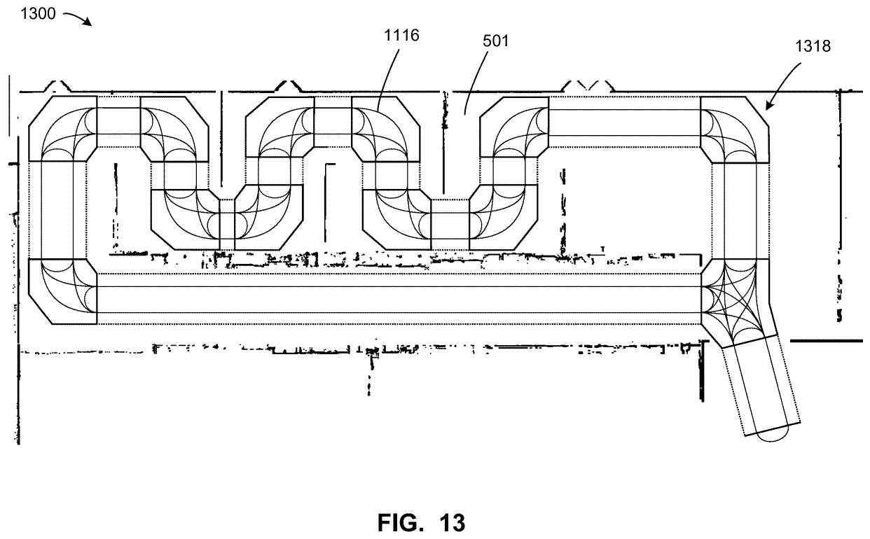

Referring to FIG. 13, shown therein is an example illustration 1300 of a road network 1318, constructed with operational paths 1116. As shown, the system 100 can use the operational paths 1116 generated from various path segments 702 and intersections 706 to construct the road network 1318. In some embodiments, the system 100 can construct the road network 1318 using operational paths 1116 generated from one or more endpoints 710 and/or spaces 714. The self-driving vehicle 110 can use the road network 1318 to navigate the environment 501.

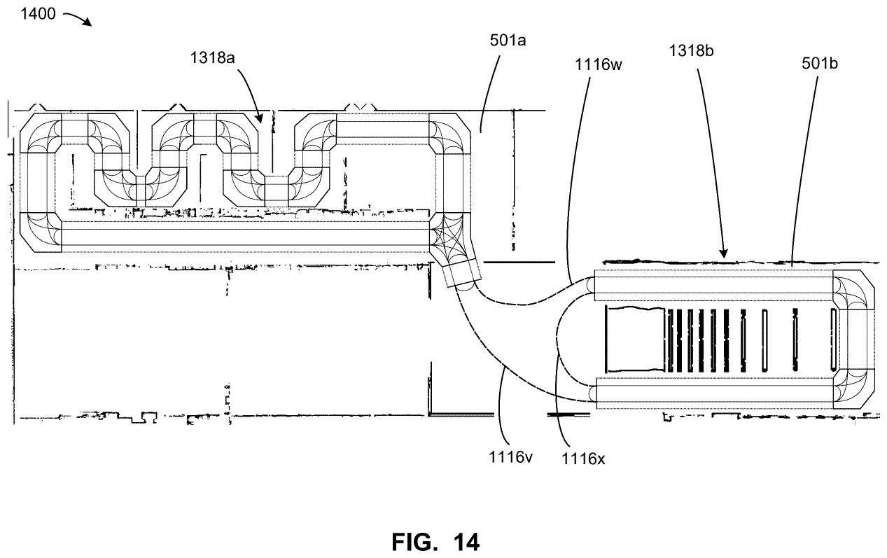

In some embodiments, the road network 1318 corresponds to an entire environment 501 (e.g., an entire facility). In some embodiments, the road network 1318 corresponds to a portion of an environment 501 (e.g., a zone, area, or department of a facility). In embodiments in which the road network 1318 corresponds to a portion of an environment 501, the system 100 can automatically connect road networks 1318 corresponding to different portions of the environment 501. Referring to FIG. 14, shown therein is an example illustration 1400 of an environment 501 (e.g., a facility) with two separate areas 501a and 501b. Each area 501a and 501b has its own corresponding road network 1318a and 1318b, constructed by the system 100. The system 100 can detect that road network 1318a is disconnected from neighbouring road network 1318b, each of which is constructed for the same self-driving vehicle 110. In response to detecting the disconnected neighbouring road network 1318b, the system 100 can automatically generate operational paths 1116v to 1116x to connect road network 1318a to road network 1318b, and operate the self-driving vehicle 110 to autonomously navigate between the road networks 1318a and 1318b.

Returning to FIG. 4, at step 460, the system 100 operates the self-driving vehicle 110 to collect environmental data while autonomously navigating the environment 501 for updating the road network 1318.

In some embodiments, the self-driving vehicle 110 can use one or more sensors 220 to collect environmental data. In some embodiments, the system 100 can determine from the environmental data that a variation to the road network 1318 is required based on at least one or more of an operational incompatibility with the navigation features provided by the user and an environmental change. An operational incompatibility can include any incompatibility between the navigation features and the road network 1318 that prevents the self-driving vehicle 110 from successfully and/or safely navigating the environment 501. An environmental change can include any change to the environment 501 such as but not limited to, a new obstacle 513, a change to an intersection 706 (e.g., a removed connecting path segment 702), or a moved endpoint 710.

In some embodiments, the environmental data can include image data. In some embodiments the environment 501 can include markings and/or objects identifiable in the image data. For example, the environment 501 can include line markings on the floor demarcating self-driving vehicle paths from human walkways, storage, etc. As another example, the environment 501 can include signs or other markings identifying stations, doors, docking targets, and/or any other relevant landmark. The system 100 can identify such markings and objects in the image data, and can use such identified markings and objects to update the road network 1318. For example, a self-driving vehicle 110 may navigate the environment 501 and collect image data depicting a stop sign that is displayed at an intersection 706 in the environment 501. If the corresponding intersection 706 of the road network 1318 constructed for the self-driving vehicle 110 does not have a “stop” approach behaviour 709, the system 100 can automatically update the road network 1318 to reflect a stop approach behaviour 709 based on the image data.

In some embodiments, the environmental data can include LiDAR data for tracking one or more targets and/or objects in the environment 501. In some embodiments, the environmental data can include sensor data collected from one or more single beam laser sensors on the self-driving vehicle 110, which can determine a distance between the self-driving vehicle 110 and one or more objects in the environment 501. In some embodiments, the environmental data can include updated drawings, maps, and/or floorplans of the environment 501.

The present invention has been described here by way of example only. Various modifications and variations may be made to these exemplary embodiments without departing from the spirit and scope of the invention, which is limited only by the appended claims.

We claim:

1. A method for interpreting navigation features provided by a user for constructing a road network autonomously navigable for at least one self-driving vehicle, the method comprising:
receiving the navigation features provided by the user for an environment, the navigation features comprising at least one navigable path and one or more navigation constraints for the environment;
evaluating the navigable features based at least on one or more vehicle properties of a self-driving vehicle to construct the road network for the self-driving vehicle, comprising:
decomposing the at least one navigable path into one or more path segments and one or more intersections based on the one or more navigation constraints provided by the user;
generating one or more operational paths for the self-driving vehicle by adapting each path segment and each intersection to accommodate for the one or more vehicle properties of the self-driving vehicle; and
constructing the road network for the self-driving vehicle with the one or more operational paths; and
operating the self-driving vehicle to collect environmental data while autonomously navigating the environment for updating the road network.

2. The method of claim 1, wherein generating the one or more operational paths for the self-driving vehicle by adapting each path segment and each intersection to accommodate for the one or more vehicle properties of the self-driving vehicle comprises, for each path segment:
evaluating whether the one or more navigation constraints provided by the user is compatible with the one or more vehicle properties; and
in response to determining that the one or more vehicle properties is incompatible with the one or more navigation constraints, adapting that path segment to accommodate the one or more vehicle properties and the one or more navigation constraints.

3. The method of claim 1, wherein:
decomposing the at least one navigable path into one or more path segments and one or more intersections based on the one or more navigation constraints provided by the user comprises identifying an end point from the navigation features; and
generating the one or more operational paths for the self-driving vehicle to incorporate characteristics of the end point.

4. The method of claim 1, wherein generating the one or more operational paths for the self-driving vehicle by adapting each path segment and each intersection to accommodate for the one or more vehicle properties of the self-driving vehicle comprises:
determining an intersection type of each intersection;
determining one or more available operational movements for the self-driving vehicle at the intersection type based on the one or more vehicle properties of the self-driving vehicle; and
generating the one or more operational paths to account for the one or more available operational movements.

5. The method of claim 1, wherein decomposing the at least one navigable path into the one or more path segments and the one or more intersections based on the one or more navigation constraints provided by the user comprises:
determining an intersection type of each intersection; and
automatically incorporating relevant navigation prompts at that intersection between the one or more path segments.

6. The method of claim 1, wherein decomposing the at least one navigable path into the one or more path segments and the one or more intersections based on the one or more navigation constraints provided by the user comprises:
determining one or more path characteristics defined by the user for each path segment; and
assigning the one or more path characteristics to that path segment.

7. The method of claim 1, wherein operating the self-driving vehicle to collect the environmental data while autonomously navigating the environment for updating the road network comprises:
operating a sensor system coupled to the self-driving vehicle for collecting the environmental data; and
determining from the environmental data that a variation to the road network is required based at least on one or more of an operational incompatibility with the navigation features provided by the user and an environmental change.

8. The method of claim 1, wherein the at least one self-driving vehicle comprises a first self-driving vehicle having a first set of vehicle properties and a second self-driving vehicle having a second set of vehicle properties, and evaluating the navigable features based at least on the one or more vehicle properties of the self-driving vehicle to construct the road network for the self-driving vehicle comprises:
constructing a first road network for the first self-driving vehicle and a second road network for the second self-driving vehicle, the first road network being different from the second road network.

9. The method of claim 1 further comprises:
detecting the road network is disconnected from a neighbouring road network constructed for the self-driving vehicle; and
in response to detecting the neighbouring road network, operating the self-driving vehicle to autonomously navigate between the road network and the neighbouring road network.

10. A system for interpreting navigation features provided by a user for constructing a road network autonomously navigable for at least one self-driving vehicle, the system comprising:
the at least one self-driving vehicle operable to autonomously navigate the road network; and
a processor operable to:
receive the navigation features provided by the user for an environment, the navigation features comprising at least one navigable path and one or more navigation constraints for the environment;
evaluate the navigable features based at least on one or more vehicle properties of a self-driving vehicle to construct the road network for the self-driving vehicle, comprising:
decomposing the at least one navigable path into one or more path segments and one or more intersections based on the one or more navigation constraints provided by the user;
generating one or more operational paths for the self-driving vehicle by adapting each path segment and each intersection to accommodate for the one or more vehicle properties of the self-driving vehicle; and
constructing the road network for the self-driving vehicle with the one or more operational paths; and
operate the self-driving vehicle to collect environmental data while autonomously navigating the environment for updating the road network.

11. The system of claim 10, wherein generating the one or more operational paths for the self-driving vehicle by adapting each path segment and each intersection to accommodate for the one or more vehicle properties of the self-driving vehicle comprises, for each path segment:
evaluating whether the one or more navigation constraints provided by the user is compatible with the one or more vehicle properties; and
in response to determining that the one or more vehicle properties is incompatible with the one or more navigation constraints, adapting that path segment to accommodate the one or more vehicle properties and the one or more navigation constraints.

12. The system of claim 10, wherein:
decomposing the at least one navigable path into one or more path segments and one or more intersections based on the one or more navigation constraints provided by the user comprises identifying an end point from the navigation features; and
the processor is further operable to generate the one or more operational paths for the self-driving vehicle to incorporate characteristics of the end point.

13. The system of claim 10, wherein generating the one or more operational paths for the self-driving vehicle by adapting each path segment and each intersection to accommodate for the one or more vehicle properties of the self-driving vehicle comprises:
determining an intersection type of each intersection;
determining one or more available operational movements for the self-driving vehicle at the intersection type based on the one or more vehicle properties of the self-driving vehicle; and
generating the one or more operational paths to account for the one or more available operational movements.

14. The system of claim 10, wherein decomposing the at least one navigable path into the one or more path segments and the one or more intersections based on the one or more navigation constraints provided by the user comprises:
determining an intersection type of each intersection; and
automatically incorporating relevant navigation prompts at that intersection between the one or more path segments.

15. The system of claim 10, wherein decomposing the at least one navigable path into the one or more path segments and the one or more intersections based on the one or more navigation constraints provided by the user comprises:
determining one or more path characteristics defined by the user for each path segment; and
assigning the one or more path characteristics to that path segment.

16. The system of claim 10, wherein operating the self-driving vehicle to collect the environmental data while autonomously navigating the environment for updating the road network comprises:
operating a sensor system coupled to the self-driving vehicle for collecting the environmental data; and
determining from the environmental data that a variation to the road network is required based at least on one or more of an operational incompatibility with the navigation features provided by the user and an environmental change.

17. The system of claim 10, wherein the at least one self-driving vehicle comprises a first self-driving vehicle having a first set of vehicle properties and a second self-driving vehicle having a second set of vehicle properties, and evaluating the navigable features based at least on the one or more vehicle properties of the self-driving vehicle to construct the road network for the self-driving vehicle comprises:
constructing a first road network for the first self-driving vehicle and a second road network for the second self-driving vehicle, the first road network being different from the second road network.

18. The system of claim 10, wherein the processor is further operable to:
detect the road network is disconnected from a neighbouring road network constructed for the self-driving vehicle; and
in response to detecting the neighbouring road network, operate the self-driving vehicle to autonomously navigate between the road network and the neighbouring road network.
